(19) United States
(12) Patent Application Publication
(10) Pub. No.: US 2007/0080321 A1
(43) Pub. Date: Apr. 12, 2007

(54) Liquid Cure Promoter Compositions With Suppressed Solids Forming Tendencies and Their Uses

(75) Inventor: Wenfeng Kuang, Baton Rouge, LA (US)

Correspondence Address: Albemarle Corporation, 451 Florida Street, Baton Rouge, LA, 70801-1765, US

(73) Assignee: ALBEMARLE CORPORATION, Baton Rouge, LA (US)

(21) Appl. No.: 11/533,071

(22) Filed: Sep. 19, 2006

Related U.S. Application Data
(60) Provisional application No. 60/724,973, filed on Oct. 7, 2005.

(51) Int. Cl. C09K 3/00

(52) U.S. Cl. 252/182.13

(57) ABSTRACT

This invention provides a cure promoter composition with suppressed solids forming tendencies. The composition is formed from components which prior to use in forming the composition are comprised of: a) N-methyl-N-(2-hydroxyethyl)-p-toluidine or N,N-bis(2-hydroxyethyl)-p-toluidine, or both; and b) at least one liquid monomeric ester of acrylic acid and/or at least one liquid monomeric ester of methacrylic acid; a) and b) being proportioned such that the a):b) weight ratio is in the range of about 50:50 to about 99:1.

### REFERENCE TO RELATED APPLICATION

This application claims the benefit and priority of U.S. Provisional Application No. 60/724,973, filed Oct. 7, 2005, the disclosure of which is incorporated herein by reference.

### TECHNICAL FIELD

This invention relates to keeping specified liquid polymerization promoters free of solids formation at lower temperatures and/or for longer periods of time at room temperatures than temperatures or time periods at which solids normally tend to form therein.

### BACKGROUND

N-methyl-N-(2-hydroxyethyl)-p-toluidine and N,N-bis(2-hydroxyethyl)-p-toluidine are known cure promoters. See for example U.S. Pat. Nos. 6,114,470; 6,258,894; and 6,774,193, the entire disclosures of which are incorporated herein by reference. As produced, these compounds are liquids. Unfortunately however, during storage or transportation these compounds typically undergo solids formation. At about room temperatures solids formation can occur in a matter of hours, and at lower temperatures the rate at which solids formation occurs is increased. As between the two cure promoters, solids formation in N,N-bis(2-hydroxyethyl)-p-toluidine tends to occur sooner than in N-methyl-N-(2-hydroxyethyl)-p-toluidine.

A need thus exists for a way of suppressing the solids forming tendencies of these compounds, e.g., by keeping these compounds in the liquid state at lower temperatures and/or at room temperatures for longer periods of time. In doing so, it is important to ensure that the effectiveness of these compounds as cure promoters is not impaired to any unacceptable extent. It is also important to ensure that the properties of formulations in which these cure promoters are utilized are not impaired to any unacceptable extent.

### BRIEF SUMMARY OF THE INVENTION

This invention provides a way of satisfying the above need without impairing to any material extent the effectiveness of these compounds as cure promoters or the properties of formulations in which these cure promoters can be utilized.

Pursuant to this invention there is provided a cure promoter composition with suppressed solids formation tendencies, i.e., a depressed solids formation temperature and/or increased resistance to solids formation at room temperatures, which composition is formed from components which prior to use in forming the composition are comprised of:
a) N-methyl-N-(2-hydroxyethyl)-p-toluidine or N,N-bis(2-hydroxyethyl)-p-toluidine, or both; and
b) at least one liquid monomeric ester of acrylic acid and/or at least one liquid monomeric ester of methacrylic acid;
   a) and b) being proportioned such that the a):b) weight ratio is in the range of about 50:50 to about 99:1.

For convenience, the monomeric ester(s) used pursuant to this invention will often be referred to hereinafter as liquid (meth)acrylate monomer(s).

Preferably the cure promoter compositions of this invention as formed are in the solids-free liquid state. However, as formed, they can be in the form of solids or solids-containing liquids and converted into a solids-free liquid state by heating to a mild temperature typically in the range of about 35 to about 45° C.

Methods of carrying out various curing operations or steps involved in such operations with the compositions of this invention are also provided by this invention.

The above and other features or embodiments of this invention will be still further apparent from the ensuing description and appended claims.

### FURTHER DETAILED DESCRIPTION OF THIS INVENTION

N-Methyl-N-(2-hydroxyethyl)-p-toluidine and N,N-bis(2-hydroxyethyl)-p-toluidine can be prepared by methods known in the art. For example, N-methyl-N-(2-hydroxyethyl)-p-toluidine can be prepared by adding a slight molar excess of ethylene oxide to N-methyl-p-toluidine and subjecting the mixture to conditions sufficient to ethoxylate the nitrogen atom of the N-methyl-p-toluidine. Another method which can be used to prepare N-methyl-N-(2-hydroxyethyl)-p-toluidine involves alkylating N-(2-hydroxyethyl)-p-toluidine using formaldehyde and hydrogen in the presence of palladium on carbon catalyst under suitable temperature and pressure conditions. N,N-bis(2-hydroxyethyl)-p-toluidine can be prepared from p-toluidine and 2-chloroethanol using alkylation conditions described for example in CS 171619 (Oct. 10, 1976) or in JP Kokai 03/181447 (Aug. 7, 1991).

When using a mixture N-methyl-N-(2-hydroxyethyl)-p-toluidine and N,N-bis(2-hydroxyethyl)-p-toluidine these compounds can be present in any proportions relative to each other, i.e., ranging from a trace of one to a trace of the other.

Any liquid (meth)acrylate monomer(s) can be used in the practice of this invention, such as liquid monomers containing up to six ester functional groups per molecule, such as, for example, erythritol tetraacrylate, erythritol tetramethacrylate, polyester triacrylate, polyester tetraacrylate, and polyester hexaacrylate. More usually, liquid (meth)acrylate monomer(s) used are (i) one or more liquid acrylate monomers having one, two, or three ester functional groups per molecule, (ii) one or more liquid methacrylate monomers having one, two, or three ester functional groups per molecule, or (iii) combinations of (i) and (ii). Preferably the one, two, or three esterifying groups are hydrocarbyl groups, e.g., in the case of liquid (meth)acrylate monomer(s) having one ester functionality per molecule the hydrocarbyl group can be alkyl (which can be linear or branched), alkenyl (which can be linear or branched), cycloalkyl, alkylcycloalkyl, alkenylcycloalkyl, aryl, alkylaryl, or aralkyl (i.e, acrylic acid or methacrylic acid is esterified by one or more monohydric alcohols and/or phenols so that there is one ester functional group per molecule), and in the case of liquid (meth)acrylate monomer(s) having two or three ester functionalities per molecule there is one central hydrocarbyl group carrying two or three ester functionalities thereon (i.e, acrylic acid or methacrylic acid is esterified with one or more dihydric or trihydric alcohols or phenols so that there are two or three ester functional groups per molecule). Combinations or mixtures of two or more different acrylate monomers, combinations or mixtures of two or more different methacrylate monomers, or combinations or mixtures of one or more acrylate monomers and one or more methacrylate monomers can be used as liquid (meth)acrylate monomer(s).

Typical liquid (meth)acrylate monomer(s) used in the practice of this invention can be depicted by the following general formulas:
CH₂═CHCOOR
CH₂═C(CH₃)COOR
RCOOCH═CH₂
RCOOC(CH₃)═CH₂
R[COOCH═CH₂]₂
R[COOC(CH₃)═CH₂]₂
R[COOCH═CH₂]₃
R[COOC(CH₃)═CH₂]₃
where in each respective formula R is preferably a hydrocarbyl group which can be the same or different. However, R can be substituted or contain other functionality as well, e.g., ether oxygen atoms, amino substituents, substituted amino groups, free carboxyl groups, or other substituents which do not interfere with the functioning of the cure promoter composition itself or with its suppressed solids formation characteristics.

In the above formulas the total carbon content of the liquid (meth)acrylate monomer(s) is not critical provided that the product is in the liquid state at ambient room temperatures (and preferably at temperatures below ambient room temperatures).

Non-limiting examples of liquid (meth)acrylate monomer(s) which can be used in the practice of this invention, either singly or in mixtures, include methyl acrylate, methyl methacrylate, ethyl acrylate, ethyl methacrylate, butyl acrylate, butyl methacrylate, 2-ethylhexyl acrylate, 2-ethylhexyl methacrylate, lauryl acrylate, lauryl methacrylate, cyclohexyl acrylate, cyclohexyl methacrylate, isobornyl acrylate, isobornyl methacrylate, hydroxyethyl acrylate, hydroxyethyl methacrylate, dimethylaminopropyl acrylate, dimethylaminopropyl methacrylate, diethylaminopropyl acrylate, diethylaminopropyl methacrylate, ethylene glycol diacrylate, ethylene glycol dimethacrylate, 1,4-butanediol diacrylate, 1,4-butanediol dimethacrylate, 1,6-hexanediol diacrylate, 1,6-hexanediol dimethacrylate, diethylene glycol diacrylate, diethylene glycol dimethacrylate, dipropylene glycol diacrylate, dipropylene glycol dimethacrylate, tripropylene glycol diacrylate, tripropylene glycol dimethacrylate, tripropylene glycol dimethacrylate, trimethylolpropane triacrylate, trimethylolpropane trimethacrylate, glycerol diacrylate, glycerol dimethacrylate, aliphatic urethane diacrylate, aliphatic urethane dimethacrylate, aliphatic urethane triacrylate, aromatic urethane diacrylate, aromatic urethane dimethacrylate, aromatic urethane triacrylate, polyethylene glycol (400) diacrylate, polyethylene glycol (400) dimethacrylate, polyethylene glycol (600) diacrylate, polyethylene glycol (600) dimethacrylate, and the like, as well as mixtures of any two or more thereof.

A large number of various liquid (meth)acrylate monomer(s) suitable for use in the practice of this invention are available from a number of commercial suppliers.

The relative proportions of N-methyl-N-(2-hydroxyethyl)-p-toluidine and/or N,N-bis(2-hydroxyethyl)-p-toluidine (component a)), and liquid (meth)acrylate monomer(s), (component b)), can vary from an a):b) weight ratio of about 50:50 to about 99:1 as long as the amount of liquid (meth)acrylate monomer(s) in the mixture constitutes a minor solids-suppressing amount. In this connection, the term “minor solids-suppressing amount” means that the amount of component b) used, which is no more than 50 wt % of the combined weight of components a) and b), is at least sufficient to (i) produce a measurable depression in the temperature at which the mixture of components a) and b) begins to form solids as compared to the temperature at which a sample of the same batch of component a) by itself begins to form solids and/or (ii) prolong the period of time during which the mixture of components a) and b) remains free of solids while at room temperature (e.g., around 23° C.) as compared to the period of time during which a sample of the same batch of component a) by itself remains free of solids at the same room temperature. The amount of component b) that will constitute a minor solids-suppressing amount will vary depending upon the makeup of components a) and b) being used, the particular extent of solids suppression desired, the temperatures to which the composition will be exposed, and the amount and identity of other components, if any, used in forming the composition. Thus in any case where the precise amounts of given components a) and b) in a given composition for achieving suitable solids suppression has not already been established, use of a few simple preliminary laboratory tests can be utilized. Although about 99 wt % of component a) and about 1 wt % of component b) may provide a suitable solids suppression, it is more desirable to use about 97 or 98 wt % of component a) and about 3 to 2 wt % of component b), respectively. Preferred proportions utilize components a) and b) in weight ratios in the range of about 80:20 to about 99:1. More preferred weight ratios of components a) and b) are in the range of about 90:10 to about 99:1. Even more preferably, the weight ratios of components a) and b) are in the range of about 95:5 to about 99:1; still more preferred are weight ratios of components a) and b) in the range of about 95:5 to about 98:2 or 97:3.

To form the compositions of this invention the components thereof are mixed together in any suitable manner typically using suitable mixing apparatus such as a blending tank or vessel equipped with suitable agitation or stirring means.

In the event that prior to mixing component b) therewith, component a) is in solid form or is in the form of a liquid in which some of component a) has changed into solids, component a) should be heated to a mild temperature (e.g., in the range of 45 to 50° C. to transform component a) back into a solids-free liquid. Similarly, if after a period of time, a composition formed from components a) and b) has undergone solids formation, the composition should be heated to a mild temperature (e.g., in the range of 35 to 45° C. to transform the mixture into a solids-free liquid. As an example, this invention provides a method wherein a composition is formed from components a) and b) and is stored and/or transported at about 23° C. without solids formation occurring for at least 96 hours after:
1) component a) has been produced;
2) component a) has been heated to convert solids thereof into the liquid state by heating; or
3) the composition has been heated to convert solids therein into the liquid state by heating.

Additional components may be included in a solids-free liquid cure promoter compositions of this invention in forming compositions which remain solids-free. In this case, care should be exercised in selecting one or more additional components which do not adversely affect the reduced temperature liquidity of the original composition or the solids forming tendencies of the original composition in any material way. Such selections can readily be made in any doubtful case by conducting a few simple tests. Alternatively, the solids-free liquid cure promoter compositions of this invention may be combined with additional components in forming solids-containing liquid compositions.

Non-limiting examples of additional components which may be used as described above include unsaturated polymer resins such as one or more of those described in U.S. Pat. Nos. 6,114,470; 6,258,894; or 6,774,193, common inert organic solvents, other cure promoters such as tertiary aromatic amines, suitably soluble organic metal salts, or mixtures of such amines and metal salts. A few examples of such tertiary aromatic amines include, without limitation, N,N-dimethylaniline, N,N-diethylaniline, N-ethyl-N-methylaniline, N,N-dimethyl-p-toluidine, N,N-bis(2-hydroxyethyl)-m-toluidine, and mixtures of any two or more such amines. A few non-limiting examples of suitable metal salt promoters that may be included include cobalt, vanadium, zirconium, iron, manganese, chromium, tin, aluminum, lead, or copper salts of such organic acids as one or more C₆₋₂₀ carboxylic acids, benzoic acid, or naphthenic acid. Mixtures of such salts can also be included as additional components of the liquid cure promoter compositions of this invention.

When additional components such as those referred to above are included in the liquid cure promoter compositions of this invention, the amounts of the components can be in the range of about 50.1 to about 99 wt % of component a), in the range of about 1 to about 49.9 wt % of component b), and the balance, if any, to 100 wt % being one or more additional components. More desirably, the proportions are in the range of about 50.1 to about 97 or 98 wt % of component a), in the range of about 2 or 3 wt % to about 49.9 wt % of component b), and the balance, if any, to 100 wt % being one or more additional components. Preferably these proportions are in the range of about 50.1 to about 80 wt % of component a), in the range of about 4 to about 20 wt % of component b), and the balance, if any, to 100 wt % being one or more additional components. More preferably these proportions are in the range of about 50.1 to about 90 wt % of component a), in the range of about 5 to about 10 wt % of component b), and the balance, if any, to 100 wt % being one or more additional components.

By virtue of the wider range of temperatures at which the liquid cure promoter compositions of this invention can be stored, handled, or used without solids formation occurring in the compositions, this invention also provides a variety of improved processing operations in which they are used. A first such improvement is in a method as fully described in U.S. Pat. No. 6,258,894 for curing crosslinkable unsaturated polymer resins with a peroxide initiator in the presence of a promoter. This first improvement pursuant to this invention comprises conducting the methods described in that patent using as cure promoter in forming the crosslinkable formulation, a solids-free liquid cure promoter composition of this invention as described in the specification and/or claims hereof. One preferred embodiment of this invention is that of the foregoing first improvement wherein component a) that is used in forming said liquid cure promoter composition is N-methyl-N-(2-hydroxyethyl)-p-toluidine and wherein component b) that is used in forming the liquid cure promoter composition has in the range of 1 to 3 ester functional groups per molecule. Another preferred embodiment of this invention is that of the foregoing first improvement wherein component a) that is used in forming said liquid cure promoter composition is N,N-bis(2-hydroxyethyl)-p-toluidine and wherein component b) that is used in forming the liquid cure promoter composition has in the range of 1 to 3 ester functional groups per molecule.

A second improvement is in a method as fully described in U.S. Pat. No. 6,774,193 of preparing a curable, pre-promoted unsaturated polymer resin system comprising combining (i) a vinyl ester resin comprising the reaction product of a polyepoxide and an ethylenically unsaturated carboxylic acid with (ii) a cure promoter to form a pre-promoted curable polymer system. This second improvement pursuant to this invention comprises conducting the methods as described in that patent using as cure promoter in preparing the curable, pre-promoted unsaturated polymer resin system, a solids-free liquid cure promoter composition of this invention as described in the specification and/or claims hereof. One preferred embodiment of this invention is that of the foregoing second improvement wherein component a) that is used in forming said liquid cure promoter composition is N-methyl-N-(2-hydroxyethyl)-p-toluidine and wherein component b) that is used in forming the liquid cure promoter composition has in the range of 1 to 3 ester functional groups per molecule. Another preferred embodiment of this invention is that of the foregoing second improvement wherein component a) that is used in forming said liquid cure promoter composition is N,N-bis(2-hydroxyethyl)-p-toluidine and wherein component b) that is used in forming said liquid cure promoter composition has in the range of 1 to 3 ester functional groups per molecule.

A third improvement is in a method as fully described in U.S. Pat. No. 6,114,470 for bonding a curing crosslinkable composition to a surface of a substrate wherein a crosslinkable composition comprised of a crosslinkable unsaturated polymer resin, a peroxide initiator, and a cure promoter is applied to such surface and the composition is cured. This third improvement pursuant to this invention comprises using as cure promoter in forming the crosslinkable composition, a solids-free liquid cure promoter composition of this invention as described in the specification and/or claims hereof. One preferred embodiment of this invention is that of the foregoing third improvement wherein component a) that is used in forming the liquid cure promoter composition is N-methyl-N-(2-hydroxyethyl)-p-toluidine and wherein component b) that is used in forming said liquid cure promoter composition has in the range of 1 to 3 ester functional groups per molecule. Another preferred embodiment of this invention is that of the foregoing third improvement wherein component a) that is used in forming said liquid cure promoter composition is N,N-bis(2-hydroxyethyl)-p-toluidine and wherein component b) that is used in forming said liquid cure promoter composition has in the range of 1 to 3 ester functional groups per molecule.

In addition to lowering the temperatures at which the foregoing improved processing operations can be carried out using N-methyl-N-(2-hydroxyethyl)-p-toluidine or N,N-bis(2-hydroxyethyl)-p-toluidine, or both without incurring solids formation, and thereby broadening the operating temperature ranges over which these cure promoters can be effectively used, this invention provides still other benefits. For example, it is deemed likely that over a suitable use concentration range, liquid cure promoter compositions of this invention formed from components a) and b) should have about the same reactivity as equal concentrations of the same neat cure promoter. Also, it is deemed likely that the compositions of this invention formed from components a) and b) should have about the same stability in uncured unsaturated polyester formulations as equal concentrations of the same neat cure promoter.

The following Examples are illustrative of the practice and advantages of this invention. These Examples are not intended to limit, and should not be construed as limiting, this invention to only what is described therein.

### EXAMPLES 1-5

Five liquid cure promoter compositions of this invention composed solely of components a) and b) were prepared by blending the components together in specified proportions and with stirring at ambient room temperature. Separate portions of each initially solids-free, visually clear composition of this invention were held at 37° F. (ca. 3° C.) for 3 days and observed for appearance of solids. Component a) in these evaluations was in each case either N-methyl-N-(2-hydroxyethyl)-p-toluidine (MHPT) or N,N-bis(2-hydroxyethyl)-p-toluidine (BHPT) each of which was solids-free at the start of the evaluations. Component b) in these evaluations were various liquid (meth)acrylate monomer(s) used individually in the respective liquid cure promoter compositions of this invention, namely hexanediol diacrylate (HDDA), butyl acrylate (BA), and methyl methacrylate (MMA). The makeup of the liquid cure promoter compositions and the results obtained in these tests are summarized in Table 1.

TABLE 1

| | Exam- | Exam- | Exam- | Exam- | Exam- |
|---|---|---|---|---|---|
| Component(s) | ple 1 | ple 2 | ple 3 | ple 4 | ple 5 |
| BHPT | 9.5 g | 9.5 g | | | |
| MHPT | | | 9.5 g | 9.5 g | 9.5 g |
| HDDA | 0.5 g | | 0.5 g | | |
| BA | | 0.5 g | | 0.5 g | |
| MMA | | | | | 0.5 g |
| Results | | | | | |
| 3 days @ 37° F. | liquid | liquid | liquid | liquid | liquid |

In contrast to the results in Table 1, as seen from Table 2, individual control samples of BHPT and of MHPT resulted in solids formation in much shorter periods of time.

TABLE 2

| Sample | Results Obtained |
|---|---|
| MHPT | At 55° F. (ca. 13.3° C.) solids appeared overnight |
| | (i.e., within ca. 12 hours) |
| BHPT | At 74° F. (23° C.) solids appeared within 12 hours |

It is to be understood that the ingredients referred to by chemical name or formula anywhere in the specification or claims hereof, whether referred to in the singular or plural, are identified as they exist prior to coming into contact with another substance referred to by chemical name or chemical type (e.g., another reactant, a solvent, a diluent, or etc.). It matters not what preliminary chemical changes, transformations and/or reactions, if any, take place in the resulting mixture or solution or reaction medium as such changes, transformations and/or reactions are the natural result of bringing the specified reactants and/or components together under the conditions called for pursuant to this disclosure. Thus the reactants and other materials are identified as ingredients to be brought together in connection with performing a desired chemical reaction or in forming a mixture to be used in conducting a desired reaction. Also, even though the claims hereinafter may refer to substances, components and/or ingredients in the present tense (“comprises”, “is”, etc.), the reference is to the substance or ingredient as it existed at the time just before it was first contacted, blended or mixed with one or more other substances or ingredients in accordance with the present disclosure. The fact that the substance or ingredient may have lost its original identity through a chemical reaction or transformation or complex formation or assumption of some other chemical form during the course of such contacting, blending or mixing operations, is thus wholly immaterial for an accurate understanding and appreciation of this disclosure and the claims thereof. Nor does reference to an ingredient by chemical name or formula exclude the possibility that during the desired reaction itself an ingredient becomes transformed to one or more transitory intermediates that actually enter into or otherwise participate in the reaction. In short, no representation is made or is to be inferred that the named ingredients must participate in the reaction while in their original chemical composition, structure or form.

Each and every patent or other publication or published document referred to in any portion of this specification is incorporated in toto into this disclosure by reference, as if fully set forth herein.

Except as may be expressly otherwise indicated, the article “a” or “an” if and as used herein is not intended to limit, and should not be construed as limiting, a claim to a single element to which the article refers. Rather, the article “a” or “an” if and as used herein is intended to cover one or more such elements, unless the text expressly indicates otherwise.

This invention is susceptible to considerable variation in its practice. Therefore the foregoing description is not intended to limit, and should not be construed as limiting, the invention to the particular exemplifications presented hereinabove. Rather, what is intended to be covered is as set forth in the ensuing claims and the equivalents thereof permitted as a matter of law.

That which is claimed is:

1. A cure promoter composition with suppressed solids forming tendencies, which composition is formed from components which prior to use in forming the composition are comprised of:
a) N-methyl-N-(2-hydroxyethyl)-p-toluidine or N,N-bis(2-hydroxyethyl)-p-toluidine, or both; and
b) at least one liquid monomeric ester of acrylic acid and/or at least one liquid monomeric ester of methacrylic acid;
a) and b) being proportioned such that the a):b) weight ratio is in the range of about 50:50 to about 99:1.

2. A composition as in claim 1 wherein said weight ratio is in the range of about 80:20 to about 99:1.

3. A composition as in claim 1 wherein said weight ratio is in the range of about 90:10 to about 99:1.

4. A composition as in claim 1 wherein said weight ratio is in the range of about 95:5 to about 99:1.

5. A composition as in claim 1 wherein component a) that is used in forming said composition is N-methyl-N-(2-hydroxyethyl)-p-toluidine.

6. A composition as in claim 1 wherein component a) that is used in forming said composition is N,N-bis(2-hydroxyethyl)-p-toluidine.

7. A composition as in claim 1 wherein component a) that is used in forming said composition is a mixture of N-methyl-N-(2-hydroxyethyl)-p-toluidine and N,N-bis(2-hydroxyethyl)-p-toluidine.

8. A composition as in claim 1 wherein said at least one liquid monomeric ester of acrylic acid and/or at least one liquid monomeric ester of methacrylic acid has in the range of 1 to 3 ester functional groups per molecule.

9. A composition as in claim 1 wherein component b) that is used in forming said composition is comprised of methyl methacrylate, butyl acrylate, or hexanediol diacrylate.

10. A composition as in claim 4 wherein component a) that is used in forming said composition is N-methyl-N-(2-hydroxyethyl)-p-toluidine and wherein component b) that is used in forming said composition is (i) at least one liquid monomeric ester of acrylic acid having in the range of 1 to 3 ester functional groups per molecule and/or (ii) at least one liquid monomeric ester of methacrylic acid having in the range of 1 to 3 ester functional groups per molecule.

11. A composition as in claim 4 wherein component a) that is used in forming said composition is N,N-bis(2-hydroxyethyl)-p-toluidine and wherein component b) that is used in forming said composition is (i) at least one liquid monomeric ester of acrylic acid having in the range of 1 to 3 ester functional groups per molecule and/or (ii) at least one liquid monomeric ester of methacrylic acid having in the range of 1 to 3 ester functional groups per molecule.

12. In a method for curing crosslinkable unsaturated polymer resins with a peroxide initiator in the presence of at least a promoter, the improvement which comprises using as a component in forming the crosslinkable formulation, a cure promoter composition which is formed from components which prior to use in forming the composition are comprised of:
a) N-methyl-N-(2-hydroxyethyl)-p-toluidine or N,N-bis(2-hydroxyethyl)-p-toluidine, or both; and
b) at least one liquid monomeric ester of acrylic acid and/or at least one liquid monomeric ester of methacrylic acid;
a) and b) being proportioned such that the a):b) weight ratio is in the range of about 50:50 to about 99:1.

13. The improvement according to claim 12 wherein said at least one liquid monomeric ester of acrylic acid and/or at least one liquid monomeric ester of methacrylic acid has in the range of 1 to 3 ester functional groups per molecule.

14. The improvement according to claim 12 wherein component a) that is used in forming said cure promoter composition is N-methyl-N-(2-hydroxyethyl)-p-toluidine and wherein component b) that is used in forming said cure promoter composition is (i) at least one liquid monomeric ester of acrylic acid having in the range of 1 to 3 ester functional groups per molecule and/or (ii) at least one liquid monomeric ester of methacrylic acid having in the range of 1 to 3 ester functional groups per molecule.

15. The improvement according to claim 12 wherein component a) that is used in forming said cure promoter composition is N,N-bis(2-hydroxyethyl)-p-toluidine and wherein component b) that is used in forming said cure promoter composition is (i) at least one liquid monomeric ester of acrylic acid having in the range of 1 to 3 ester functional groups per molecule and/or (ii) at least one liquid monomeric ester of methacrylic acid having in the range of 1 to 3 ester functional groups per molecule.

16. In a method of preparing a curable, pre-promoted unsaturated polymer resin system comprising combining (i) a vinyl ester resin comprising the reaction product of a polyepoxide and an ethylenically unsaturated carboxylic acid with (ii) a cure promoter to form a pre-promoted curable polymer system, the improvement which comprises using as cure promoter in preparing the curable, pre-promoted unsaturated polymer resin system, a cure promoter composition which is formed from components which prior to use in forming the composition are comprised of:
a) N-methyl-N-(2-hydroxyethyl)-p-toluidine or N,N-bis(2-hydroxyethyl)-p-toluidine, or both; and
b) at least one liquid monomeric ester of acrylic acid and/or at least one liquid monomeric ester of methacrylic acid;
a) and b) being proportioned such that the a):b) weight ratio is in the range of about 50:50 to about 99:1.

17. The improvement according to claim 16 wherein said at least one liquid monomeric ester of acrylic acid and/or at least one liquid monomeric ester of methacrylic acid has in the range of 1 to 3 ester functional groups per molecule.

18. The improvement according to claim 16 wherein component a) that is used in forming said cure promoter composition is N-methyl-N-(2-hydroxyethyl)-p-toluidine and wherein component b) that is used in forming said cure promoter composition is (i) at least one liquid monomeric ester of acrylic acid having in the range of 1 to 3 ester functional groups per molecule and/or (ii) at least one liquid monomeric ester of methacrylic acid having in the range of 1 to 3 ester functional groups per molecule.

19. The improvement according to claim 16 wherein component a) that is used in forming said cure promoter composition is N,N-bis(2-hydroxyethyl)-p-toluidine and wherein component b) that is used in forming said cure promoter composition is (i) at least one liquid monomeric ester of acrylic acid having in the range of 1 to 3 ester functional groups per molecule and/or (ii) at least one liquid monomeric ester of methacrylic acid having in the range of 1 to 3 ester functional groups per molecule.

20. In a method for bonding a curing crosslinkable composition to a surface of a substrate wherein a crosslinkable composition comprised of a crosslinkable unsaturated polymer resin, a peroxide initiator, and a cure promoter is applied to said surface and the composition is cured, the improvement which comprises using as a cure promoter in forming the crosslinkable composition, a cure promoter composition which is formed from components which prior to use in forming the composition are comprised of:
a) N-methyl-N-(2-hydroxyethyl)-p-toluidine or N,N-bis(2-hydroxyethyl)-p-toluidine, or both; and
b) at least one liquid monomeric ester of acrylic acid and/or at least one liquid monomeric ester of methacrylic acid;
a) and b) being proportioned such that the a):b) weight ratio is in the range of about 50:50 to about 99:1.

21. The improvement according to claim 20 wherein said at least one liquid monomeric ester of acrylic acid and/or at least one liquid monomeric ester of methacrylic acid has in the range of 1 to 3 ester functional groups per molecule.

22. The improvement according to claim 20 wherein component a) that is used in forming said cure promoter composition is N-methyl-N-(2-hydroxyethyl)-p-toluidine and wherein component b) that is used in forming said cure promoter composition is (i) at least one liquid monomeric ester of acrylic acid having in the range of 1 to 3 ester functional groups per molecule and/or (ii) at least one liquid monomeric ester of methacrylic acid having in the range of 1 to 3 ester functional groups per molecule.

23. The improvement according to claim 20 wherein component a) that is used in forming said cure promoter composition is N,N-bis(2-hydroxyethyl)-p-toluidine and wherein component b) that is used in forming said cure promoter composition is (i) at least one liquid monomeric ester of acrylic acid having in the range of 1 to 3 ester functional groups per molecule and/or (ii) at least one liquid monomeric ester of methacrylic acid having in the range of 1 to 3 ester functional groups per molecule.

24. A method of suppressing the solids forming tendencies of N-methyl-N-(2-hydroxyethyl)-p-toluidine or N,N-bis(2-hydroxyethyl)-p-toluidine, or both during storage or transportation, which method comprises:
I) forming a composition comprised of:
a) N-methyl-N-(2-hydroxyethyl)-p-toluidine or N,N-bis(2-hydroxyethyl)-p-toluidine, or both; and
b) at least one liquid monomeric ester of acrylic acid and/or at least one liquid monomeric ester of methacrylic acid;
in proportions such that the a):b) weight ratio is in the range of about 50:50 to about 99:1; and
II) storing or transporting said composition.

25. A method as in claim 24 wherein said at least one liquid monomeric ester of acrylic acid and/or at least one liquid monomeric ester of methacrylic acid has in the range of 1 to 3 ester functional groups per molecule.

26. A method as in claim 24 wherein said weight ratio is in the range of about 80:20 to about 99:1.

27. A method as in claim 24 wherein said weight ratio is in the range of about 90:10 to about 99:1.

28. A method as in claim 24 wherein said weight ratio is in the range of about 95:5 to about 99:1.

29. A method as in claim 24 wherein component a) that is used in forming said composition is N-methyl-N-(2-hydroxyethyl)-p-toluidine.

30. A method as in claim 24 wherein said composition is stored and/or transported at about 23° C. without solids formation occurring for at least 72 hours after (1) component a) has been produced; (2) component a) has been heated to convert solids thereof into the liquid state by heating; or (3) the composition has been heated to convert solids therein into the liquid state by heating.

31. A method as in claim 24 wherein component a) that is used in forming said composition is N,N-bis(2-hydroxyethyl)-p-toluidine.

32. A method as in claim 31 wherein said composition is stored and/or transported at about 23° C. without solids formation occurring for at least 72 hours after (1) component a) has been produced; (2) component a) has been heated to convert solids thereof into the liquid state by heating; or (3) the composition has been heated to convert solids therein into the liquid state by heating.

33. A method as in claim 24 wherein component a) that is used in forming said composition is a mixture of N-methyl-N-(2-hydroxyethyl)-p-toluidine and N,N-bis(2-hydroxyethyl)-p-toluidine.

34. A method as in claim 33 wherein said composition is stored and/or transported at about 23° C. without solids formation occurring for at least 72 hours after (1) component a) has been produced; (2) component a) has been heated to convert solids thereof into the liquid state by heating; or (3) the composition has been heated to convert solids therein into the liquid state by heating.

35. A method as in claim 24 wherein component b) that is used in forming said composition is comprised of methyl methacrylate, butyl acrylate, or hexanediol diacrylate.
